(19) United States
(12) Patent Application Publication
(10) Pub. No.: US 2026/0088857 A1
(43) Pub. Date: Mar. 26, 2026

(54) MEASUREMENT APPARATUS AND METHOD FOR LIMITING PARAMETERS THEREOF

(71) Applicant: ANRITSU CORPORATION, Kanagawa (JP)

(72) Inventor: Yasuko UDA, Kanagawa (JP)

(21) Appl. No.: 19/325,692

(22) Filed: Sep. 11, 2025

(30) Foreign Application Priority Data
Sep. 25, 2024 (JP) 2024-166311

(51) Int. Cl. H04B 7/0413; H04B 17/309

(52) U.S. Cl. CPC H04B 7/0413; H04B 17/309

(57) ABSTRACT

Provided is a measurement apparatus that can limit a settable range of parameters according to executable functions to suppress parameter setting errors. A measurement apparatus includes a plurality of measurement devices 51A and 51B that measure SISO communication and an integrated control device 55 that controls the measurement devices 51A and 51B to measure a wireless signal transmitted and received by a DUT 1 which performs MIMO communication. The integrated control device 55 collects executable functions of each of the measurement devices 51A and 51B and limits a setting range of parameters for the MIMO communication based on the executable functions of the measurement devices 51A and 51B.

### TECHNICAL FIELD

The present invention relates to a measurement apparatus, and more particularly, to a measurement apparatus that measures a wireless signal transmitted and received by a communication device operating according to a wireless local area network (LAN) communication standard.

### BACKGROUND ART

Various wireless communication technologies have been developed with the advancement of information and communication technologies. For example, Institute of Electrical and Electronics Engineers (IEEE) 802.11ac (Very High Throughput (VHT)) and IEEE 802.11ax (High Efficiency (HE)) are known as communication standards related to the wireless LAN technology among the wireless communication technologies.

In wireless LAN communication, a single-input single-output (SISO) method in which both a transmission side and a reception side perform communication with one antenna, a multiple-input multiple-output (MIMO) method in which both the transmission side and the reception side perform communication with a plurality of antennas, and the like are used.

Patent Document 1 discloses a technique that measures a device under test which performs MIMO communication, using a plurality of SISO-type measurement devices.

### RELATED ART DOCUMENT

### Patent Document

[Patent Document 1] Japanese Patent No. 6672554

### DISCLOSURE OF THE INVENTION

### Problem that the Invention is to Solve

For this measurement device, there are some devices that are not distinguishable in appearance, are different in hardware, and have a plurality of types of hardware (hereinafter, also referred to as “hardware types”) with different functions.

When measurement devices of different hardware types are combined to measure MIMO communication, the functions that can be used may be limited depending on the combination of the hardware types.

Therefore, it is necessary to set parameters for MIMO communication in consideration of executable functions.

However, when a value outside a settable range is set as the parameter without considering the executable functions, a parameter error occurs. However, it is not possible to determine whether the cause is an operation error of the user or an error due to the executable functions.

Since the hardware types are not distinguishable in appearance, it takes a lot of time and effort to understand why the function is not available, which results in reduced usability.

Therefore, an object of the present invention is to provide a measurement apparatus that can limit a settable range of parameters according to executable functions to suppress parameter setting errors.

### Means for Solving the Problem

According to an aspect of the present invention, there is provided a measurement apparatus (50) including: a plurality of measurement devices (51A, 51B) that measure single-input single-output (SISO) communication; and an integrated control device (55) that controls the plurality of measurement devices to measure a wireless signal transmitted and received by a device under test (1) which performs multiple-input multiple-output (MIMO) communication. When the measurement devices have different executable functions, the integrated control device collects the executable functions of each of the plurality of measurement devices and limits a setting range of parameters for the MIMO communication based on the executable functions of the plurality of measurement devices.

According to this configuration, the setting range of the parameters for the MIMO communication is limited according to the executable functions of each of the plurality of measurement devices. Therefore, it is possible to suppress parameter setting errors.

In addition, in the measurement apparatus according to the aspect of the present invention, the integrated control device may disable setting of a parameter related to a non-executable function, based on the executable functions of the plurality of measurement devices, on a setting screen for the parameters for the MIMO communication.

According to this configuration, the setting of the parameter related to the non-executable function is disabled, based on the executable functions of each of the plurality of measurement devices, on the setting screen for the parameters for the MIMO communication. Therefore, it is possible to suppress parameter setting errors.

Further, in the measurement apparatus according to the aspect of the present invention, the integrated control device may display a message that prompts a user to check a function executable by the measurement device for the parameter, whose setting has been disabled, on the setting screen for the parameters for the MIMO communication.

According to this configuration, the message that prompts the user to check the executable function of the measurement device is displayed for the parameter, whose setting has been disabled due to the non-executable function, on the setting screen for the parameters for the MIMO communication. Therefore, it becomes clear that the parameters cannot be set due to the non-executable functions, and it is possible to suppress parameter setting errors.

Furthermore, according to another aspect of the present invention, there is provided a method for limiting parameters of a measurement apparatus (50) including a plurality of measurement devices (51A, 51B) that measure single-input single-output (SISO) communication and an integrated control device (55) that controls the plurality of measurement devices to measure a wireless signal transmitted and received by a device under test (1) which performs multiple-input multiple-output (MIMO) communication. The method includes: a step of collecting executable functions of each of the plurality of measurement devices; and a step of limiting a setting range of parameters for the MIMO communication based on the executable functions of the plurality of measurement devices.

According to this configuration, the setting range of the parameters for the MIMO communication is limited according to the executable functions of each of the plurality of measurement devices. Therefore, it is possible to suppress parameter setting errors.

Moreover, in the method for limiting parameters according to the aspect of the present invention, the integrated control device may disable setting of a parameter related to a non-executable function, based on the executable functions of the plurality of measurement devices, on a setting screen for the parameters for the MIMO communication.

In addition, in the method for limiting parameters according to the aspect of the present invention, the integrated control device may display a message that prompts a user to check a function executable by the measurement device for the parameter, whose setting has been disabled, on the setting screen for the parameters for the MIMO communication.

### Advantage of the Invention

The present invention can provide a measurement apparatus that can limit a settable range of parameters according to executable functions to suppress parameter setting errors.

### BRIEF DESCRIPTION OF THE DRAWINGS

FIG. 1 is a block diagram showing a measurement apparatus according to an embodiment of the present invention.

FIGS. 2A to 2C are diagrams showing an example of a setting screen for STBC and NSTS parameters of the measurement apparatus according to the embodiment of the present invention, in which FIG. 2A is a diagram showing an example of a setting screen for SISO communication, FIG. 2B is a diagram showing an example of a setting screen for STBC in MIMO communication, and FIG. 2C is a diagram showing an example of a setting screen for NSTS in MIMO communication.

FIGS. 3A to 3C are diagrams showing an example of a setting screen for a PPDU type parameter of the measurement apparatus according to the embodiment of the present invention, in which FIG. 3A is a diagram showing an example of a setting screen for SISO communication, FIG. 3B is a diagram showing an example of a setting screen for MIMO communication, and FIG. 3C is a diagram showing an example of a setting screen when an information icon of the setting screen for MIMO communication is selected.

FIGS. 4A and 4B are diagrams showing an example of a setting screen for a channel band parameter of the measurement apparatus according to the embodiment of the present invention, in which FIG. 4A is a diagram showing an example of a setting screen for SISO communication, and FIG. 4B is a diagram showing an example of a setting screen when an information icon of the setting screen for MIMO communication is selected.

FIGS. 5A to 5C are diagrams showing an example of a setting screen for a primary channel parameter of the measurement apparatus according to the embodiment of the present invention, in which FIG. 5A is a diagram showing an example of a setting screen for SISO communication, FIG. 5B is a diagram showing an example of a setting screen for MIMO communication, and FIG. 5C is a diagram showing an example of a setting screen when an information icon of the setting screen for MIMO communication is selected.

### BEST MODE FOR CARRYING OUT THE INVENTION

Hereinafter, a measurement apparatus according to an embodiment of the present invention will be described in detail with reference to the drawings.

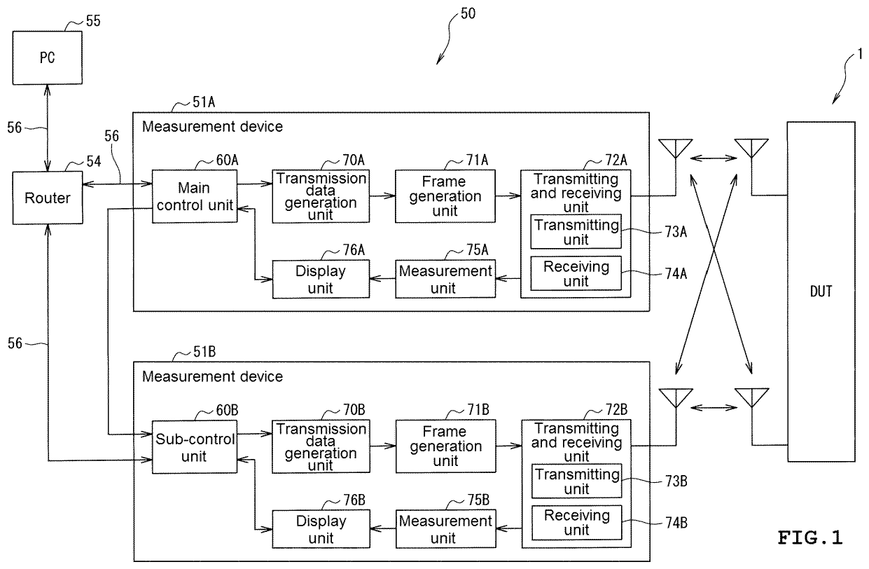

As shown in FIG. 1, a measurement apparatus 50 according to the present embodiment is connected to a DUT 1 as a device under test via a wireless LAN to measure the DUT 1. In the present embodiment, the measurement apparatus 50 operates as, for example, a wireless LAN access point (AP), and the DUT 1 operates as a wireless LAN station (STA). In addition, the measurement apparatus 50 communicates with the DUT 1 based on a communication standard conforming to IEEE 802.11ax, IEEE 802.11be, or the like.

In the present embodiment, the measurement apparatus 50 includes two measurement devices 51A and 51B, a router 54, and an integrated control device 55. The measurement device 51A and the measurement device 51B are connected to the integrated control device 55 by a network 56, such as Ethernet (registered trademark), via the router 54.

The integrated control device 55 is configured by, for example, a personal computer (PC). The integrated control device 55 communicates with the measurement devices 51A and 51B via the network 56 and the router 54 and controls both the measurement devices 51A and 51B in an integrated manner. Specifically, the integrated control device 55 sets one of the measurement devices 51A and 51B as a primary and the other as a secondary and performs, for example, control to give a command to start the measurement of the DUT1 to the primary side. In addition, FIG. 1 shows an example in which the integrated control device 55 sets the measurement device 51A as the primary and the measurement device 51B as the secondary.

In the present embodiment, the DUT 1 to be measured by the measurement apparatus 50 performs MIMO communication and has, for example, two antennas. On the other hand, each of the measurement device 51A and the measurement device 51B constituting the measurement apparatus 50 is configured to perform SISO communication.

That is, in the measurement apparatus 50, two SISO-type measurement devices 51A and 51B simultaneously transmit a series of information, that is, single-stream signals modulated by a predetermined modulation method (for example, BPSK, QPSK, or the like), from their respective antennas in parallel. The DUT 1 receives the signal using a plurality of antennas (two in the present embodiment) as if the signal is MIMO-based information and returns a response frame to the measurement apparatus 50 using the MIMO method. In this way, the measurement of the DUT 1 is established.

In addition, since the measurement devices 51A and 51B can simultaneously transmit the single-stream signals in parallel, the measurement device 51A, which is the primary, of the measurement devices 51A and 51B performs control to synchronize the transmission and reception operation timings of the measurement device 51A and the measurement device 51B. Therefore, in the measurement apparatus 50, the integrated control device 55 does not need to control the measurement device 51B after giving the command to start the measurement of the DUT1 to the measurement device 51A. According to the configuration of the measurement apparatus 50, it is not possible to communicate with the DUT 1 using the MIMO method, but it is possible to measure the DUT 1 using the MIMO method while transmitting and receiving two streams of SISO-based information in parallel. Further, it is assumed that, for example, a product, such as MT8862A, which is a wireless LAN measurement device manufactured by Anritsu Corporation, is used as each of the measurement devices 51A and 51B.

In the measurement apparatus 50, the measurement device 51A includes a control unit 60A, a transmission data generation unit 70A, a frame generation unit 71A, a transmitting and receiving unit 72A, a measurement unit 75A, and a display unit 76A. The measurement device 51A includes a microcomputer (not shown) including a central processing unit (CPU), a read only memory (ROM), a random access memory (RAM), and an input interface unit and an output interface unit to which various interfaces are connected. The measurement device 51A executes a control program stored in advance in the ROM to cause the microcomputer to function as each of the above-described functional units of the measurement device 51A.

In the measurement device 51A, the control unit 60A controls the entire measurement device 51A and performs control to synchronize the measurement device 51B with the host measurement device.

The transmission data generation unit 70A generates transmission data set by a user and outputs the generated transmission data to the frame generation unit 71A.

The frame generation unit 71A generates (configures) a frame including the data from the transmission data generation unit 70A and outputs the frame to the transmitting and receiving unit 72A.

The transmitting and receiving unit 72A includes a transmitting unit 73A and a receiving unit 74A and establishes a wireless connection with the DUT 1 based on, for example, a communication standard conforming to IEEE 802.11be. In addition, the transmitting and receiving unit 72A transmits and receives various types of data related to measurement to and from the DUT 1 after the wireless connection is established.

The transmitting unit 73A includes an encoding processing circuit, a modulation circuit, a digital-to-analog converter (DAC), an up-converter, a transmitting antenna, and the like (which are not shown), performs a process, such as digital modulation or up-conversion, on the frame generated by the frame generation unit 71A, and transmits the frame to the DUT 1 via the antenna.

The receiving unit 74A includes a receiving antenna, a down-converter, an analog-to-digital converter (ADC), a demodulation circuit, a decoding processing circuit, and the like (which are not shown), and extracts data to be measured, which is a measurement target, from the frame determined to be the measurement target among the frames received from the DUT 1, and outputs the extracted data to the measurement unit 75A.

Similarly, the measurement device 51B includes a control unit 60B, a transmission data generation unit 70B, a frame generation unit 71B, a transmitting and receiving unit 72B, a measurement unit 75B, and a display unit 76B. The control unit 60B controls the entire measurement device 51B under the control of the control unit 60A of the measurement device 51A.

In the measurement device 51B, the transmission data generation unit 70B, the frame generation unit 71B, the transmitting and receiving unit 72B, the measurement unit 75B, and the display unit 76B basically have the same configurations as the functional units of the measurement device 51A, that is, the transmission data generation unit 70A, the frame generation unit 71A, the transmitting and receiving unit 72A, the measurement unit 75A, and the display unit 76A, respectively.

Similarly to the measurement device 51A, the measurement device 51B includes a microcomputer including a CPU, a ROM, a RAM, and an input interface unit and an output interface unit to which various interfaces are connected, which are not shown. Similarly, the measurement device 51B executes a control program stored in advance in the ROM to cause the microcomputer to function as each of the above-described functional units of the measurement device 51B.

In the measurement apparatus 50, the measurement device 51A and the measurement device 51B differ from each other in that the former serves as the primary, performs control to synchronize the transmission operation timings of the transmitting unit 73A of the measurement device 51A and the transmitting unit 73B of the measurement device 51B, and performs control to synchronize the reception operation timings of the receiving unit 74A of the measurement device 51A and the receiving unit 74B of the measurement device 51B, and the latter serves as the secondary and follows the synchronization control by the former.

In order to achieve the above-described relationship between the primary and the secondary, the control unit 60A controls the entire measurement device 51A and performs control to give a transmission synchronization trigger signal and a reception synchronization trigger signal to the control unit 60B. The transmission synchronization trigger signal is a control signal for the control unit 60B to cause the transmitting unit 73B to perform a transmission operation in synchronization with the transmitting unit 73A, and the reception synchronization trigger signal is a control signal for the control unit 60B to cause the receiving unit 74B to perform a reception operation in synchronization with the receiving unit 74A.

The integrated control device 55 displays a setting screen for communication parameters for measurement on a display unit, such as a display (not shown), in response to an instruction input to an operation unit, such as a keyboard or a mouse (not shown), such that information necessary for measurement is input. In addition, the integrated control device 55 transmits an instruction to the control unit 60A of the measurement device 51A in response to an instruction input to the operation unit such that communication is established with the set parameters, measurement is performed, the result is displayed on the display unit.

In the present embodiment, the measurement device 51A and the measurement device 51B have the same housing or the like and are not capable being distinguished from each other in appearance. However, there are a plurality of hardware types with different hardware configurations, and available functions vary depending on the hardware type. In addition, the term “same” includes things that are exactly the same in appearance or so similar that they are difficult to distinguish.

Examples of the hardware type include “5GRF” that can perform communication conforming to the IEEE 802.11n/ac/ax/be standards and does not support a frequency bandwidth of 160 MHz and a frequency bandwidth of 320 MHz, “6GRF” that can perform communication conforming to the IEEE 802.11n/11ac/11ax/11be standards and does not support a frequency bandwidth of 320 MHz, and “BW320M” that can perform communication conforming to the IEEE 802.11n/11ac/11ax/11be standards and supports a frequency bandwidth of 320 MHz.

When the hardware type of the primary device is 5GRF and when the hardware type of the secondary device is 5GRF, the MIMO function conforming to the IEEE 802.11n/11ac standards is enabled.

When both the hardware type of the primary device and the hardware type of the secondary device are 6GRF and when the hardware type of the primary device is BW320M and the hardware type of the secondary device is 6GRF, the MIMO function that does not support a frequency bandwidth of 320 MHz conforming to the IEEE 802.11n/11ac/11ax/11be standards is enabled.

When both the hardware type of the primary device and the hardware type of the secondary device are BW320M, the MIMO function that supports a frequency bandwidth of 320 MHz conforming to the IEEE 802.11n/11ac/11ax/11be standards is enabled.

As described above, the executable functions of the MIMO communication are limited by the executable functions of the primary device and the secondary device. Therefore, it is necessary to set the parameters for MIMO communication in consideration of the executable functions of the primary device or the secondary device.

When a value outside a settable range is set as the parameter without considering the executable functions of the primary device or the secondary device, a parameter error occurs. However, it is not possible to determine whether the cause is an operation error of the user or an error due to the executable functions of the primary device or the secondary device.

Therefore, the integrated control device 55 according to the present embodiment collects the executable functions of the primary measurement device 51A and the secondary measurement device 51B and limits the setting range of the parameters for MIMO communication according to the executable functions of the primary measurement device 51A and the secondary measurement device 51B.

The integrated control device 55 determines, for example, the setting ranges of Space Time Block Coding (STBC) and Number of Space Time Streams (NSTS) parameters of the MIMO communication according to the executable functions of the secondary measurement device 51B.

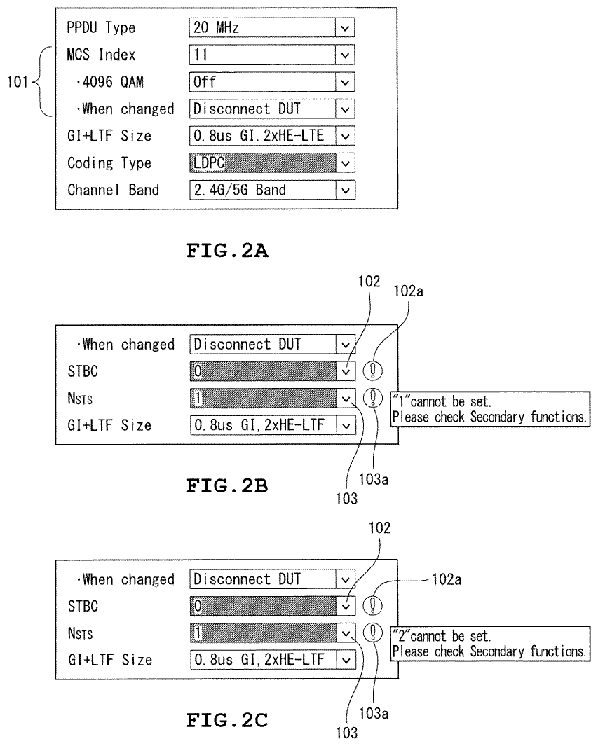

The integrated control device 55 allows the user to set the STBC and the NSTS parameters using, for example, a setting screen shown in FIGS. 2A to 2C.

FIGS. 2A to 2C show a case where the hardware type of the primary measurement device 51A is 6GRF or BW320M and the hardware type of the secondary measurement device 51B is 5GRF.

FIG. 2A shows a setting screen for SISO communication in the primary measurement device 51A. In the setting of the SISO communication, an MCS setting portion 101 for the setting of a PPDU type and the setting of MCS is displayed, but STBC and NSTS, which are parameters of the MIMO communication, are not displayed.

FIGS. 2B and 2C show a setting screen for MIMO communication, and an STBC setting portion 102 and an NSTS setting portion 103 are displayed. However, due to the limitations of the functions of the secondary measurement device 51B, the setting values of STBC and NSTS cannot be changed from “0” and “1”, respectively, and are grayed out.

An information icon 102a is displayed on the right side of the STBC setting portion 102. For example, when a mouse pointer hovers over the information icon 102a and the information icon 102a is selected, a message that indicates that “1” cannot be set and prompts the user to check the functions of the secondary device is displayed as shown in FIG. 2B.

An information icon 103a is displayed on the right side of the NSTS setting portion 103. For example, when the mouse pointer hovers over the information icon 103a and the information icon 103a is selected, a message that indicates that “2” cannot be set and prompts the user to check the functions of the secondary device is displayed as shown in FIG. 2C.

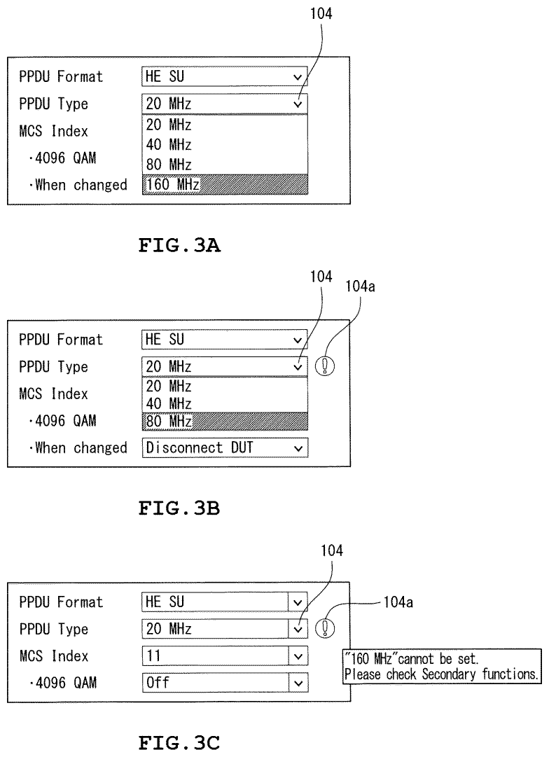

The integrated control device 55 allows the user to set a PPDU type parameter using a setting screen shown in FIGS. 3A to 3C.

FIGS. 3A to 3C show a case where the hardware type of the primary measurement device 51A is 6GRF and the hardware type of the secondary measurement device 51B is 5GRF.

FIG. 3A shows a setting screen for SISO communication in the primary measurement device 51A. In the setting of the SISO communication, when a PPDU setting portion 104 is selected by, for example, a mouse click, a drop-down list of settable values is displayed, and the settable value can be selected up to “160 MHz”.

In the setting screen for MIMO communication, due to the limitations of the functions of the secondary measurement device 51B, only up to “80 MHz” is displayed, and the information icon 104a is displayed on the right side of the PPDU setting portion 104 as shown in FIG. 3B.

For example, when the mouse pointer hovers over the information icon 104a and the information icon 104a is selected, a message that indicates that “160 MHz” cannot be set and prompts the user to check the functions of the secondary device is displayed as shown in FIG. 3C.

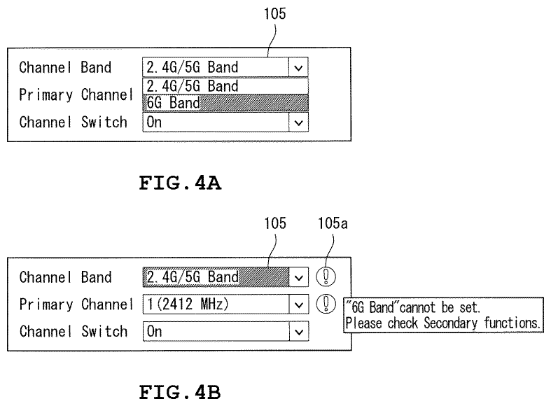

The integrated control device 55 allows the user to set a Channel Band parameter using, for example, a setting screen shown in FIGS. 4A and 4B.

FIGS. 4A and 4B show a case where the hardware type of the primary measurement device 51A is 6GRF or BW320M and the hardware type of the secondary measurement device 51B is 5GRF.

FIG. 4A shows a setting screen for SISO communication in the primary measurement device 51A. In the setting of the SISO communication, when a channel band setting portion 105 is selected by, for example, a mouse click, a drop-down list of settable values is displayed, and “2.4G/5G Band” and “6G Band” can be selected.

In the setting screen for MIMO communication, due to the limitations of the functions of the secondary measurement device 51B, the “2.4G/5G Band” is selected, cannot be changed, and is grayed out, and an information icon 105a is displayed on the right side of the channel band setting portion 105 as shown in FIG. 4B.

For example, when the mouse pointer hovers over the information icon 105a and the information icon 105a is selected, a message that indicates that “6G Band” cannot be set and prompts the user to check the functions of the secondary device is displayed as shown in FIG. 4B.

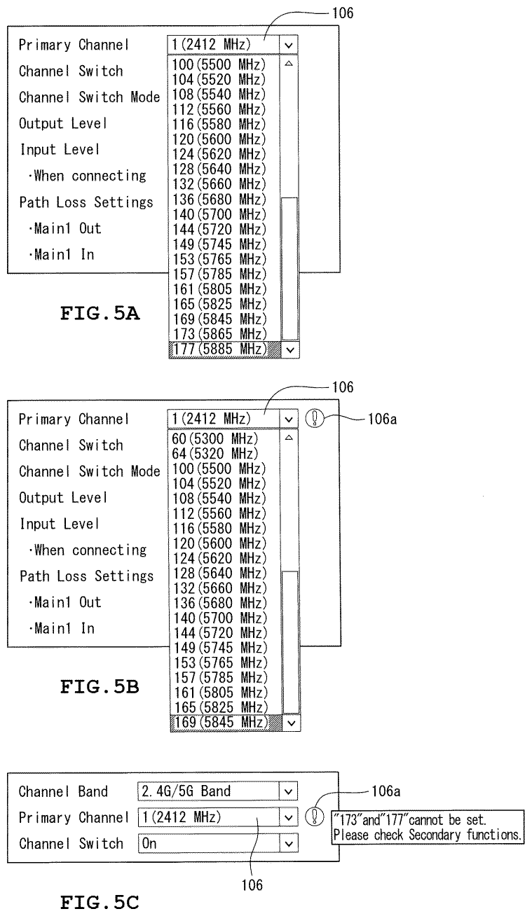

The integrated control device 55 allows the user to set a Primary Channel parameter using, for example, a setting screen shown in FIGS. 5A to 5C.

FIGS. 5A to 5C show a case where the hardware type of the primary measurement device 51A is 6GRF or BW320M and the hardware type of the secondary measurement device 51B is 5GRF.

FIG. 5A shows a setting screen for SISO communication in the primary measurement device 51A. In the setting of the SISO communication, when a primary channel setting portion 106 is selected by, for example, a mouse click, a drop-down list of settable values is displayed, and “173 (5865 MHz)” and “177 (5885 MHz)” are selectable.

In the setting of the MIMO communication, due to the limitations of the functions of the secondary measurement device 51B, only up to “169 (5845 MHz)” is displayed, and an information icon 106a is displayed on the right side of the primary channel setting portion 106 as shown in FIG. 5B.

For example, when the mouse pointer hovers over the information icon 106a and the information icon 106a is selected, a message that indicates that “173” and “177” cannot be set and prompts the user to check the functions of the secondary device is displayed as shown in FIG. 5C.

As described above, in the above-described embodiment, the integrated control device 55 collects the executable functions of each of the primary measurement device 51A and the secondary measurement device 51B and limits the setting range of the parameters for MIMO communication according to the executable functions of the primary measurement device 51A and the secondary measurement device 51B.

Therefore, the setting range of the parameters for MIMO communication is limited according to the executable functions of each of the primary measurement device 51A and the secondary measurement device 51B. As a result, it is possible to suppress parameter setting errors.

In addition, the integrated control device 55 disables the setting of parameters related to non-executable functions on the setting screen for the parameters for MIMO communication, based on the executable functions of each of the primary measurement device 51A and the secondary measurement device 51B.

Therefore, it is possible to disable the setting of the parameters related to the non-executable functions on the setting screen for the parameters for MIMO communication, based on the executable functions of each of the primary measurement device 51A and the secondary measurement device 51B. As a result, it is possible to suppress parameter setting errors.

In addition, the integrated control device 55 displays a message that prompts the user to check the executable functions of the primary measurement device 51A or the secondary measurement device 51B for the parameters that cannot be set due to the non-executable functions on the setting screen for the parameters for MIMO communication.

Therefore, the message that prompts the user to check the executable functions of the primary measurement device 51A or the secondary measurement device 51B for the parameters that cannot be set due to the non-executable functions is displayed on the setting screen for the parameters for MIMO communication. Therefore, it becomes clear that the parameters cannot be set due to the non-executable functions, and it is possible to suppress parameter setting errors.

The embodiment of the present invention has been disclosed, but it is clear that modifications can be made by those skilled in the art without departing from the scope of the present invention. All such modifications and equivalents are intended to be included in the following claims.

### DESCRIPTION OF REFERENCE NUMERALS AND SIGNS

1 DUT (Device Under Test)
50 Measurement Apparatus
51A, 51B Measurement Device
55 Integrated Control Device
56 Network
60A, 60B Control Unit

What is claimed is:

1. A measurement apparatus comprising:
a plurality of measurement devices that measure single-input single-output (SISO) communication; and
an integrated control device that controls the plurality of measurement devices to measure a wireless signal transmitted and received by a device under test which performs multiple-input multiple-output (MIMO) communication,
wherein, when the measurement devices have different executable functions, the integrated control device collects the executable functions of each of the plurality of measurement devices and limits a setting range of parameters for the MIMO communication based on the executable functions of the plurality of measurement devices.

2. The measurement apparatus according to claim 1,
wherein the integrated control device disables setting of a parameter related to a non-executable function, based on the executable functions of the plurality of measurement devices, on a setting screen for the parameters for the MIMO communication.

3. The measurement apparatus according to claim 2,
wherein the integrated control device displays a message that prompts a user to check a function executable by the measurement device for the parameter, whose setting has been disabled, on the setting screen for the parameters for the MIMO communication.

4. A method for limiting parameters of a measurement apparatus including a plurality of measurement devices that measure single-input single-output (SISO) communication and an integrated control device that controls the plurality of measurement devices to measure a wireless signal transmitted and received by a device under test which performs multiple-input multiple-output (MIMO) communication, the method comprising:
a step of collecting executable functions of each of the plurality of measurement devices; and
a step of limiting a setting range of parameters for the MIMO communication based on the executable functions of the plurality of measurement devices.

5. The method for limiting parameters according to claim 4,
wherein the integrated control device disables setting of a parameter related to a non-executable function, based on the executable functions of the plurality of measurement devices, on a setting screen for the parameters for the MIMO communication.

6. The method for limiting parameters according to claim 5,
wherein the integrated control device displays a message that prompts a user to check a function executable by the measurement device for the parameter, whose setting has been disabled, on the setting screen for the parameters for the MIMO communication.
